(19) United States
(12) Patent Application Publication
(10) Pub. No.: US 2022/0261418 A1
(43) Pub. Date: Aug. 18, 2022

(54) Methods and Systems for MultiDimensional Data Sharding in Distributed Databases

(71) Applicant: Telefonaktiebolaget LM Ericsson (publ), Stockholm (SE)

(72) Inventors: Petrit Gerdovci, Karlskrona (SE); Jim Håkansson, Karlskrona (SE); Mattias Nilsson, Rödeby (SE)

(21) Appl. No.: 17/625,276

(22) PCT Filed: Jul. 8, 2019
(86) PCT No.: PCT/SE2019/050676

§ 371 Date: Jan. 6, 2022

(51) Int. Cl. G06F 16/27; G06F 3/06

(52) U.S. Cl. CPC G06F 16/27; G06F 3/0611; G06F 3/0635; G06F 3/067

(57) ABSTRACT

Systems and methods are provided for storing customer data in a distributed database. The method including: dividing a customer's data into a plurality of different data type portions; routing the plurality of different data type portions to at least two different servers, wherein at least one of the plurality of different data type portions are routed to one of the at least two different servers and at least another of the plurality of different data portions are routed to another of the at least two different servers; and storing the plurality of different data type portions at the server to which they are routed, wherein each data type is associated with at least one of the at least two different servers based at least in part on access requirements of the customer's data for each data type.

### TECHNICAL FIELD

The present invention generally relates to communication networks and, more particularly, to mechanisms and techniques for data storage in distributed databases.

### BACKGROUND

Over time the number of products and services provided to users of telecommunication products has grown significantly. For example, in the early years of wireless communication, devices could be used for conversations and later also had the ability to send and receive text messages. Over time, technology advanced and wireless phones of varying capabilities were introduced which had access to various services provided by network operators, e.g., data services, such as streaming video or music service. More recently there are numerous devices, e.g., so called “smart” phones and tablets, which can access communication networks in which the operators of the networks, and other parties, provide many different types of services, applications, etc.

As the quantity of users, devices and services continues to grow organizations which incur large, varying processing loads are expected to have an increase in challenges with respect to timely storing, accessing and processing of data. Additionally, these organizations that utilize database systems seek to offer guarantees in regard to low latencies to their end customer. In other words, the throughput of the computational performance of a client and server should be consistent even through the peak hours of the day. However, throughput of the computational performance is not always consistent and thus these performance limitations are present in currently used multi-host networked database systems. Additionally, these performance limitations are expected to increase with growth.

In a distributed database setup, clients will store data based on a key in different servers. The requests will be routed to one of the servers, based on the key, within a cluster of database servers. The data will be persisted within the server receiving the request. Distributed databases are able to replicate data to other servers within the cluster, for data redundancy purposes, in case failure occurs to one of the servers. By routing different requests to different servers, parallelism and performance can be increased both for read and write operations.

FIG. 1 shows an example of how customer data can be stored within a distributed database using conventional techniques. Specifically, FIG. 1 shows two applications which interact with two servers in two different physical locations. It is noted that all of the different data categories, e.g., index, real-time, historical and sensitive, are stored together in each server. More specifically, the distributed database 100 includes server 106 and server 108 each of which are in communication with Application1 102 and Application2 104. Server 106 includes index data 110, real-time data 112, historical data 114 and sensitive data 116. Server 108 includes index data 118, real-time data 120, historical data 122 and sensitive data 124.

Index data 110 and 118 is stored data of a customer which can, for example, be searchable by a graphical user interface. Real-time data 112 and 120 is data which can be processed in real-time and is often processed frequently, e.g., the balance of customer's account. Historical data 114 and 122 is data which is expected to be processed less frequently than that of real-time data, but with a larger data size. For example, calculating the total cost of phone calls for a month is a processing example using historical data. Sensitive data 116 and 124 is data related to customer security, e.g., a user's login password. FIG. 1 also shows, for illustrative purposes, that a first customer data for John is stored in server 106 and a second customer data for Joe is stored in server 108. However, for redundancy purposes, both sets of customer data can be stored in each of server 106 and 108.

FIG. 1 also illustrates that applications, e.g., Application1 102 and Application2 104, are able to read customer data from both servers 106 and 108, depending on their processing need. Further, all aforementioned data will be replicated in a distributed environment. In other words, the same data is stored in one or more other servers for reducing the risk of total failure when a server crashes. Additionally, since data is typically distributed within a group of servers quite evenly, server hardware needs to be similar in order to cope with incoming traffic.

Customer data can also be stored in a relational data base. In relational, non-distributed databases, data is organized in one or more tables, with each table being associated with the so-called “named” relations. Each table consists of rows and columns in which the data is stored. In a relational database the data of different categories can be divided across different tables in the relational database.

FIG. 2 illustrates how customer data can be stored in a relational non-distributed database all in a single table, as compared to the distributed database 100 shown in FIG. 1 which has no relations. FIG. 2 includes a relational database 200 with a server 202 in communication with both Application1 102 and Application2 104. Server 202 includes index table 204, real-time table 206, historical table 208 and sensitive table 210. Index table 204 includes index data associated with customers, for example, index table 204 includes index information associated with customer John and customer Joe. Real-time table 206 includes real-time data associated with customers. Historical table 208 includes historical data associated with customers and sensitive table 210 includes sensitive data associated with customers. These different types of data are described in more detail earlier in the Background section.

FIG. 3 shows an example of a signaling diagram for setting up customers, and associated data, using a distributed database. FIG. 3 includes a distributed database 300 which includes database1 (DB1) 302, DB2 304 and DB3 306, each of which includes one or more servers which are in communication with Application 307. Initially, in step 308, the function create customer1 is performed. An account for customer1 is created in DB1 302 by the Application 307 transmitting one or more messages to DB1 302 as shown by arrow 310. The one or more messages represented by arrow 310 include information about customer1 which can include, for example, a customerid, a name, a pin-code and a phone call price.

In step 312, the function create customer2 is performed. An account for customer2 is created in DB2 304 by the Application 307 transmitting one or more messages to DB2 304 as shown by arrow 314. The one or more messages represented by arrow 314 contain information about customer2 which can include, for example, a customerid, a name, a pin-code and a phone call price. In step 316, the function create customer3 is performed. An account for customer3 is created in DB3 306 by the Application 308 transmitting one or more messages to DB3 306 as shown by arrow 318. The one or more messages represented by arrow 318 include information about customer 1 which can include, for example, a customerid, a name, a pine-code and a phone call price. Further, as this is a conventional distributed data system, it is expected that the data can be replicated in each of the databases.

In relational and distributed databases, all types of data are typically stored together. For example, in a telecom system, a customer's data can be categorized into various parts. Real-time data which includes data about a customer, e.g., name, address and ongoing transactions. Historical data which includes data such as call detail record (CDR) information. CDR information can include information about who the customer is calling and the duration of the call as well as invoices which a customer has accumulated. Index data includes data of the customer which can be indexed for searching, e.g., a customer's full name and phone name can be indexed. This allows for a customer care (CC) system to determine a customer's name based on his or her phone number. Sensitive data can include portions of a customer's data which is desired to be encrypted, e.g., a personal identification number (PIN).

These types of data are normally stored together. Thus, at the end of the month when invoices are to be calculated for each customer, a large load occurs on the servers maintaining all of the various customers' data. One solution to the issues associated with such a large processing load is to scale the server cluster by adding more servers for processing. However, this solution can be costly while still not guaranteeing that the real-time data processing is undisturbed. In other words, the system cannot achieve isolation between the various types of jobs which need to be processed against the data maintained in the system.

Thus, there is a need to provide methods and systems that overcome the above-described drawbacks associated with data distribution and data processing.

### SUMMARY

Embodiments allow for having designated groups of servers per datatype to achieve full isolation between data being processed between the different server groups. This can provide an advantage which customers seek in order to provide a good customer experience by, for example, providing low latency.

According to an embodiment, there is a method for storing customer data in a distributed database. The method including: dividing a customer's data into a plurality of different data type portions; routing the plurality of different data type portions to at least two different servers, wherein at least one of the plurality of different data type portions are routed to one of the at least two different servers and at least another of the plurality of different data portions are routed to another of the at least two different servers; and storing the plurality of different data type portions at the server to which they are routed, wherein each data type is associated with at least one of the at least two different servers based at least in part on access requirements of the customer's data for each data type.

According to an embodiment, there is a system for storing customer data in a distributed database. The system including: a logical routing layer configured to divide a customer's data into a plurality of different data type portions; the logical routing layer further configured to rout the plurality of different data type portions to at least two different servers, wherein at least one of the plurality of different data type portions are routed to one of the at least two different servers and at least another of the plurality of different data portions are routed to another of the at least two different servers, wherein the logical routing layer exists at least on the two different servers and on at least one client device; and the servers, to which the plurality of different data type portions is routed, are configured to store the plurality of different data type portions, wherein each type of data is associated with at least one of the at least two different servers based at least in part on access requirements of the customer's data for each data type.

According to an embodiment, there is a computer-readable storage medium containing a computer-readable code that when read by a processor causes the processor to perform a method for storing customer data in a distributed database. The method including: dividing a customer's data into a plurality of different data type portions; routing the plurality of different data type portions to at least two different servers, wherein at least one of the plurality of different data type portions are routed to one of the at least two different servers and at least another of the plurality of different data portions are routed to another of the at least two different servers; and storing the plurality of different data type portions at the server to which they are routed, wherein each data type is associated with at least one of the at least two different servers based at least in part on access requirements of the customer's data for each data type.

According to an embodiment, there is an apparatus adapted to divide a customer's data into a plurality of different data type portions; to route the plurality of different data type portions to at least two different servers, wherein at least one of the plurality of different data type portions are routed to one of the at least two different servers and at least another of the plurality of different data portions are routed to another of the at least two different servers; and to store the plurality of different data type portions at the server to which they are routed, wherein each data type is associated with at least one of the at least two different servers based at least in part on access requirements of the customer's data for each data type.

According to an embodiment, there is an apparatus including: a first module configured to divide a customer's data into a plurality of different data type portions; a second module configured to route the plurality of different data type portions to at least two different servers, wherein at least one of the plurality of different data type portions are routed to one of the at least two different servers and at least another of the plurality of different data portions are routed to another of the at least two different servers; and a third module configured to store the plurality of different data type portions at the server to which they are routed, wherein each data type is associated with at least one of the at least two different servers based at least in part on access requirements of the customer's data for each data type.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates how customer data can be stored within a distributed database;

FIG. 2 shows how customer data can be stored within a relational non-distributed database;

FIG. 3 shows an example of a signaling diagram for setting up customers, and associated data, using a distributed database;

FIG. 4 depicts a database (DB) system according to an embodiment;

FIG. 5 shows how one or more datatypes can be stored on a same server according to an embodiment;

FIGS. 6A-6D show a signaling diagram for creating customers according to an embodiment;

FIG. 7 illustrates an architecture which can support various use cases according to an embodiment;

FIG. 8 shows a signaling diagram associated with a Customer Care (CC) call example according to an embodiment;

FIG. 9 illustrates a signaling diagram associated with charging activities associated with a phone call;

FIG. 10 depicts a signaling diagram which illustrates a periodic bill run according to an embodiment;

FIG. 11 shows an architecture with a complete system at a site and a partial system at a remote site according to an embodiment;

FIG. 12 shows a flowchart of a method for storing customer data in a distributed database according to an embodiment;

FIG. 13 depicts a server according to an embodiment; and

FIG. 14 depicts an electronic storage medium on which computer program embodiments can be stored.

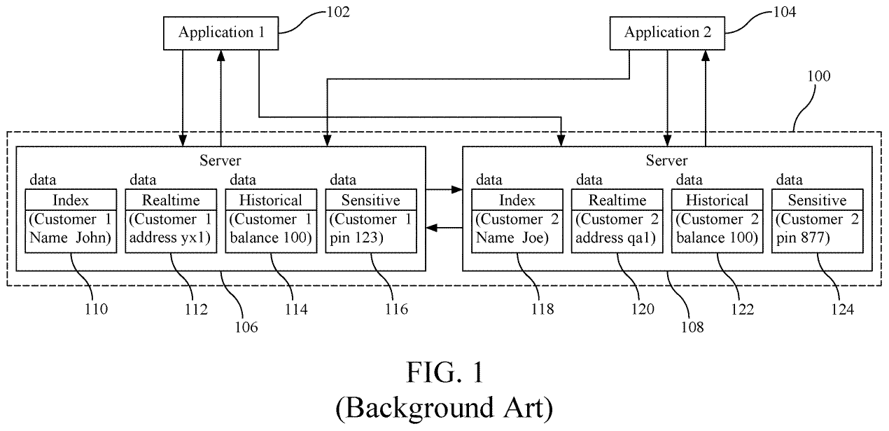

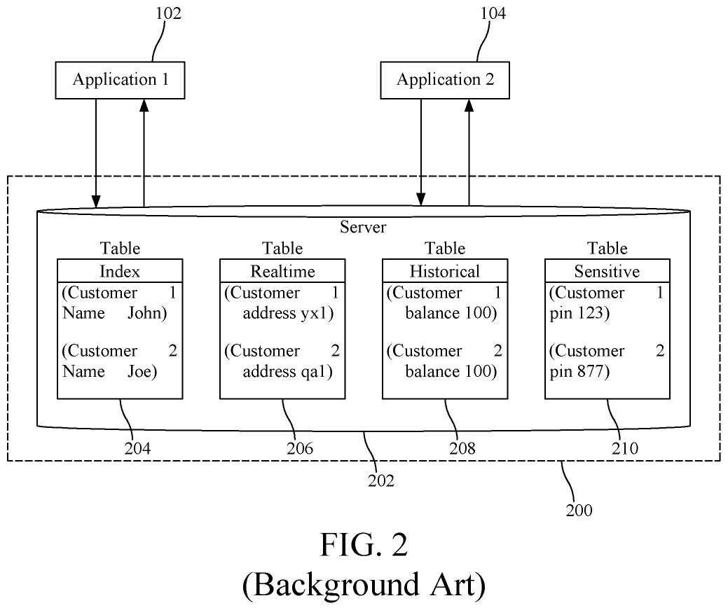

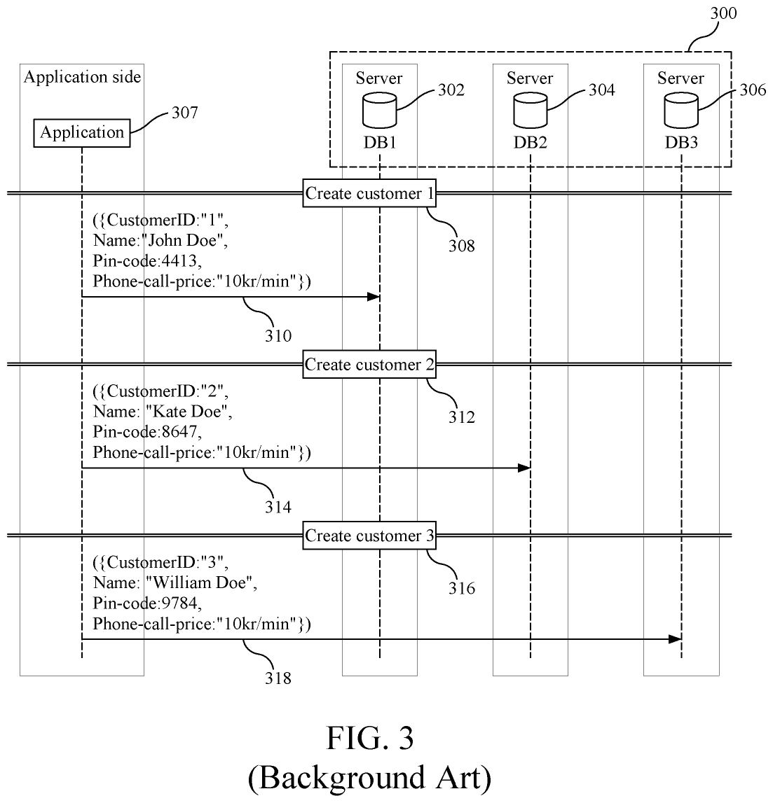

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As described in the Background section, there are problems associated with data distribution and data processing. Embodiments described herein provide systems and methods for dividing unique categories of customer data into different dedicated groups of servers by distributing the load and processing to each designated group of servers. For example, according to an embodiment, there can be designated groups of servers per customer datatypes where client applications can be responsible to categorize their data according to different data types. The database (DB) system ensures that the different data types are stored separately, where desired, according to pre-defined partitioning information. Each customer datatype is associated with different data categories for each customer.

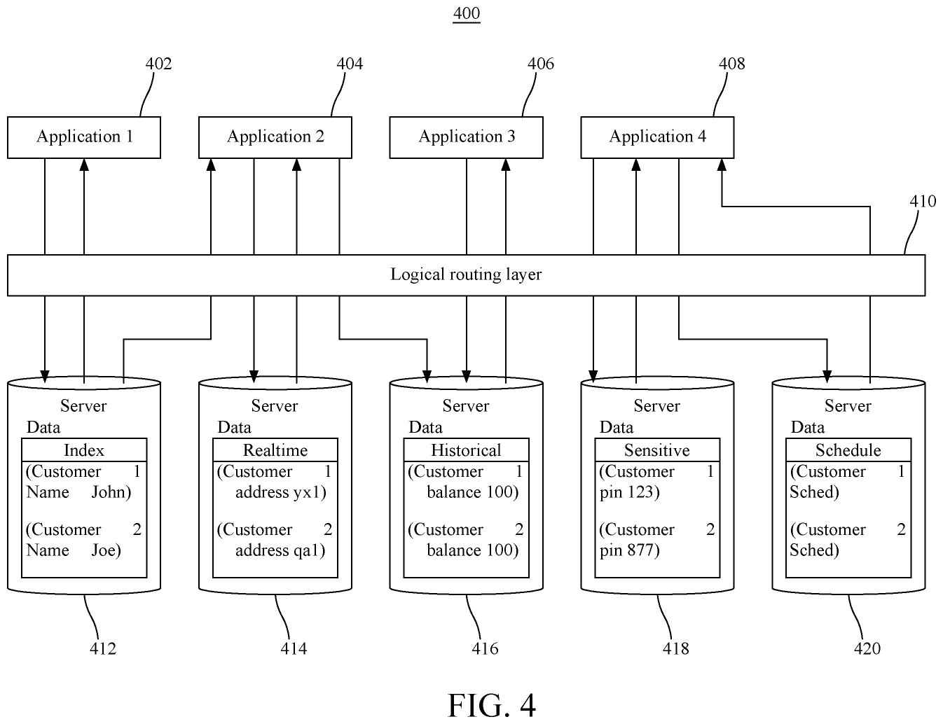

According to an embodiment, there can be a DB system 400 which uses designated servers (or server groups) per datatype as shown in FIG. 4. FIG. 4 includes a plurality of Applications, e.g., Application1 402, Application2 404, Application3 406 and Application4 408, a logical routing layer 410 and a plurality of servers/server groups, e.g., index data server 412, real-time data server 414, historical data server 416, sensitive data server 418 and schedule data server 420. One or more applications can interact with one or more desired servers or server groups, depending upon the application's need. For example, as shown in FIG. 4, Application1 402 is in communication, via the logical routing layer 410, with the index data server 412 to, for example, save or retrieve customer name(s) for searching. Application2 404 is in communication, via the logical routing layer 410, with both the index data server 412 and the historical data server 404 to, for example, save or retrieve both customer name and CDR information. Since index, real-time, historical and sensitive data have been previously described in the Background section these datatypes are not further defined here. However, another data server group “schedule” has been added which can store data associated with known job schedules for the different servers. An example of the schedule datatype is a timestamp, e.g., a timestamp associated with when the last scheduled job was run. This data could then be used by the system to know when the next time should be for running the scheduler. Further, the types of data servers shown herein is not intended to be limiting and it is understood that more or fewer types of data servers can be implemented as desired.

According to an embodiment, based on the access frequency, the data storage capacity needs and the use of the data server, different types of hardware can be used to both optimize the system and to reduce system costs. For example, the index data server 412 is a high access system with relatively low data storage requirements, as compared to the historical data server 416. As such a solid state drive (SSD) can be used to store data in data server 412. As the historical data server 416 has a lower access frequency with a larger data storage requirement, a spinning disk system can be used to store data in server 416. With regards to the sensitive data server 418, encrypted hardware, as well as tokens, can be used with the data storage system to protect the sensitive data.

According to an embodiment, replication factors can be used to decide server redundancy and data storage requirements. For example, it may be desirable to have a single index data server 412 and/or a real-time server 414 for each site. Regarding the historical data server 416 it may be desirable to have multiple historical data server 416 groups at a single site to provide both large amounts of data and to provide data security by replication. Additionally, for the schedule data server 420 it may be that only a single server at a single site provides enough coverage for the entire system.

According to an embodiment, the logical routing layer 410 performs routing of the different types of data between applications and servers. For example, an application can specify the datatype of the data to be stored or retrieved and the logical routing layer 410 then handles the routing to or from the appropriate DB server. The logical routing layer 410 can be manually configured to route requests to the specific servers based on datatypes or an artificial intelligence can be implemented in the routing layer to decide where requests should be routed. In execution, it is expected that there will be many databases created for each datatype, however, for the various applications it will appear as one common database where all of the datatypes are stored, curtesy of the logical routing layer 410.

The logical routing layer 410 is depicted herein as a single entity to indicate that the number and locations of the servers is not necessarily known by, nor is the information necessarily needed by, any of the applications which interact with the various data servers. According to an embodiment, the logical routing layer 410, can include as a single separate entity, more accurately represents a client side portion (associated with the various applications) and a server side portion associated with the data servers. According to an embodiment, the client side portion sends initial information towards the server side portion which directs the initial information to the desired server, e.g., the index server. Further, according to an embodiment, the client side of the logical routing layer 410 can store information which can assist in indicating to which servers information and queries for customers needs to be sent. Additionally, the client side can include an information tag which indicates to the logical routing layer 410 the type of data being sent or requested which is used in forwarding the data being sent or requested to the correct type of data server, e.g., index, historical, etc. With regards to the server side portion, routing can be hardcoded such that real-time data goes to one server group and security data goes to another server group. Alternatively, some for of artificial intelligence using logic can be used for optimizing the storage.

Considering this description of the logical routing layer, an example using FIG. 4 is now described. Initially, Application1 402 forwards data associated with a new customer and their address. The logical routing layer 410 forwards this data to the index server 412 which decides that the real-time server 414 should process this data and appropriately forwards the data to real-time server 414. After processing the data, real-time server 414 sends information back to Application1 402 via the logical routing layer 410 which includes a tag for future routing use associated with this customer and type of data.

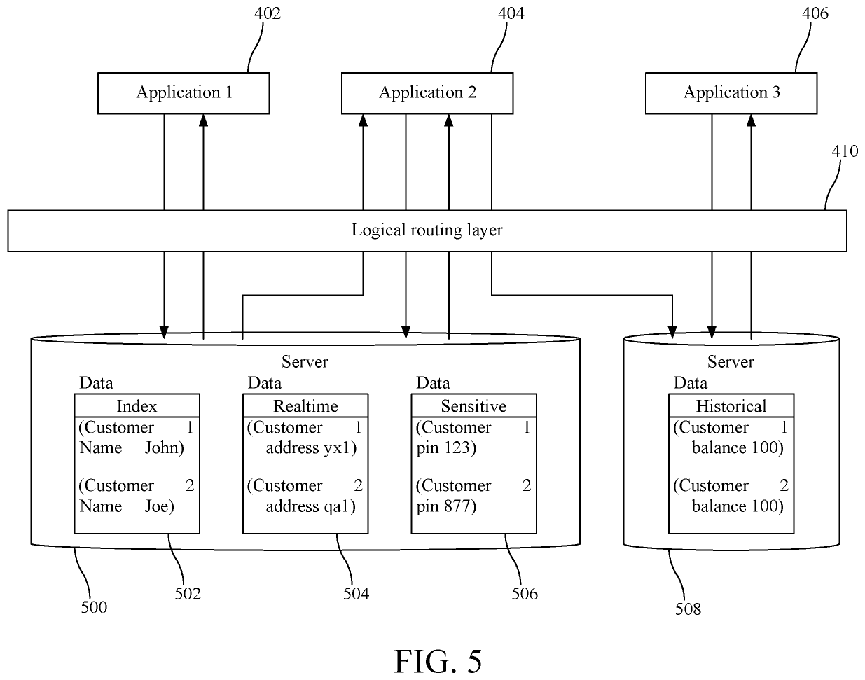

According to the embodiment of FIG. 4, each different type of data can have its own server/different hardware configuration. However, according to another embodiment, one or more datatypes can be stored on a same server as shown in FIG. 5. FIG. 5 includes Application1 402, Application2, 404, Application3 406, logical routing layer 410, server 500 and historical data server 508. The system shown in FIG. 5 operates similarly to that shown in FIG. 4, except that server 500 stores index data 502, real-time data 504 and customer data 506. It is to be understood that for the various embodiments described herein data can be stored on a stand-alone server, on a server group or with other types of data on one or more servers as desired.

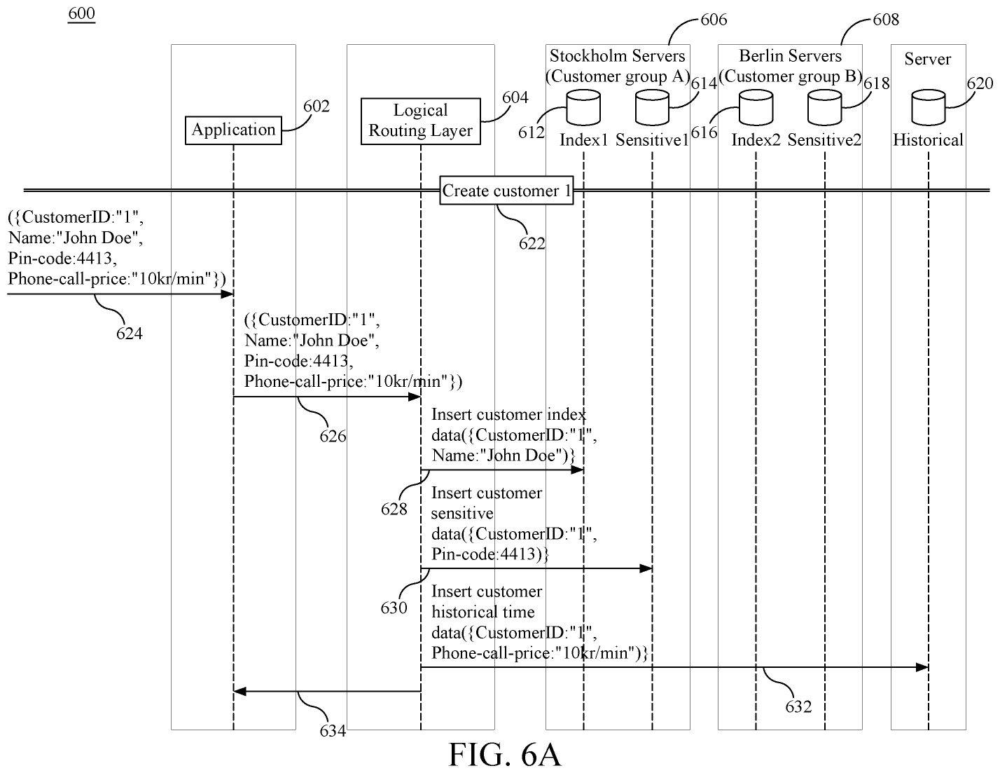

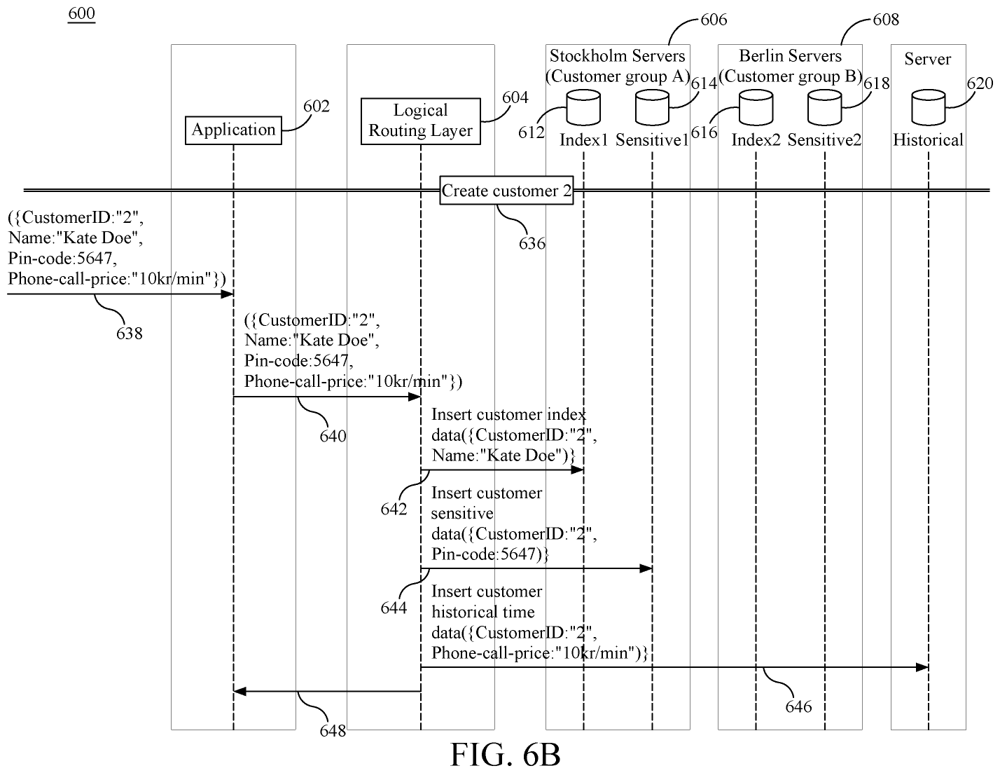

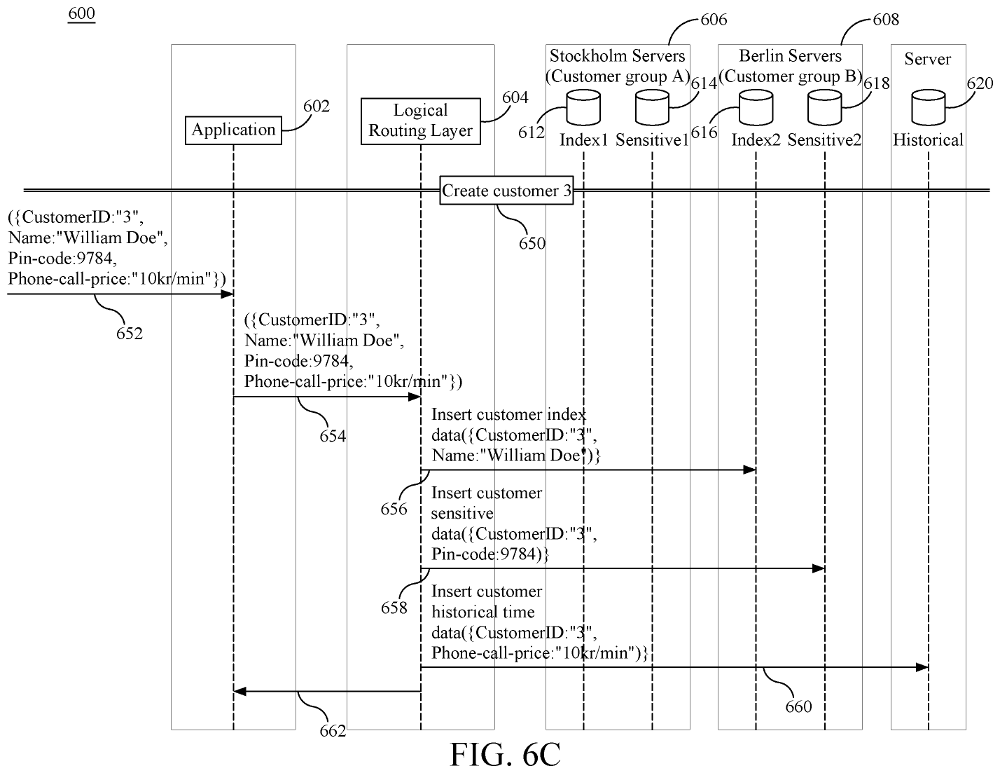

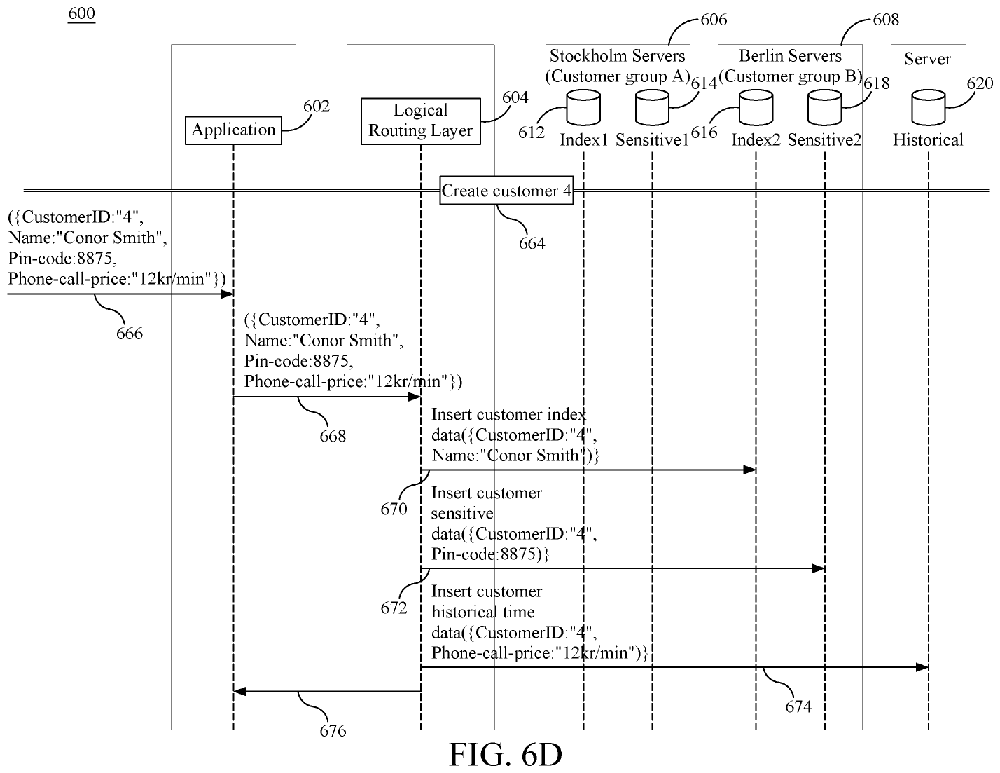

According to an embodiment, FIGS. 6A-6D show a signaling diagram 600 for creating customer information for different customers associated with two different sites. FIGS. 6A-6D show an Application 602, a logical routing layer 604, Stockholm servers 606, Berlin servers 608 and historical server 620. The Stockholm servers 606 include index1 server 612 and sensitive1 server 614. The Berlin servers 608 include index2 server 616 and sensitive2 server 618.

FIG. 6A shows a process for creating customer1 622 according to an embodiment. Initially, Application1 602 receives information 624 associated with customer John Doe. Application1 602 process the received information 624 as necessary and forwards the information 626 to the logical routing layer 604. The logical routing layer 604 splits the received information and forwards each piece of received information to the appropriate server. More specifically, a CustomerID and name is sent in message 628 to the index1 server 612, the CustomerID and pin-code is sent in message 630 to sensitive data server1 614, and the CustomerID and phone call price is sent in message 632 to the historical server 620. Upon completion of these activities some form of acknowledgement/completion message 634 is transmitted from the logical routing layer 604 to Application 602.

FIG. 6B shows a process for creating customer2 636 according to an embodiment. Initially, Application1 602 receives information 638 associated with customer Kate Doe. Application1 602 process the received information 638 as necessary and forwards the information 640 to the logical routing layer 604. The logical routing layer 604 splits the received information and forwards each piece of received information to the appropriate server. More specifically, a CustomerID and name is sent in message 642 to the index1 server 612, the CustomerID and pin-code is sent in message 644 to sensitive data server1 614, and the CustomerID and phone call price is sent in message 646 to the historical server 620. Upon completion of these activities some form of acknowledgement/completion message 648 is transmitted from the logical routing layer 604 to Application 602.

FIG. 6C shows a process for creating customer3 650 according to an embodiment. Initially, Application1 602 receives information 652 associated with customer William Doe. Application1 602 process the received information 652 as necessary and forwards the information 654 to the logical routing layer 604. The logical routing layer 604 splits the received information and forwards each piece of received information to the appropriate server. More specifically, a CustomerID and name is sent in message 656 to the index2 server 616, the CustomerID and pin-code is sent in message 658 to sensitive data server2 618, and the CustomerID and phone call price is sent in message 660 to the historical server 620. Upon completion of these activities some form of acknowledgement/completion message 662 is transmitted from the logical routing layer 604 to Application 602.

FIG. 6D shows a process for creating customer1 664 according to an embodiment. Initially, Application1 602 receives information 666 associated with customer Conor Smith. Application1 602 process the received information 666 as necessary and forwards the information 668 to the logical routing layer 604. The logical routing layer 604 splits the received information and forwards each piece of received information to the appropriate server. More specifically, a CustomerID and name is sent in message 670 to the index2 server 616, the CustomerID and pin-code is sent in message 672 to sensitive data server2 618, and the CustomerID and phone call price is sent in message 674 to the historical server 620. Upon completion of these activities some form of acknowledgement/completion message 676 is transmitted from the logical routing layer 604 to Application 602.

According to an embodiment, the database system described in various embodiments can be used in support of a business support system (BSS). A BSS is composed of a set of components which telecommunication service providers use to operate several types of business operations towards customers. For example, there can be a customer care (CC) service, which is a part of the BSS, which allows for telecommunication service providers to manage their customers' information. A CC agent can be responsible for managing customers and interactions with the customers.

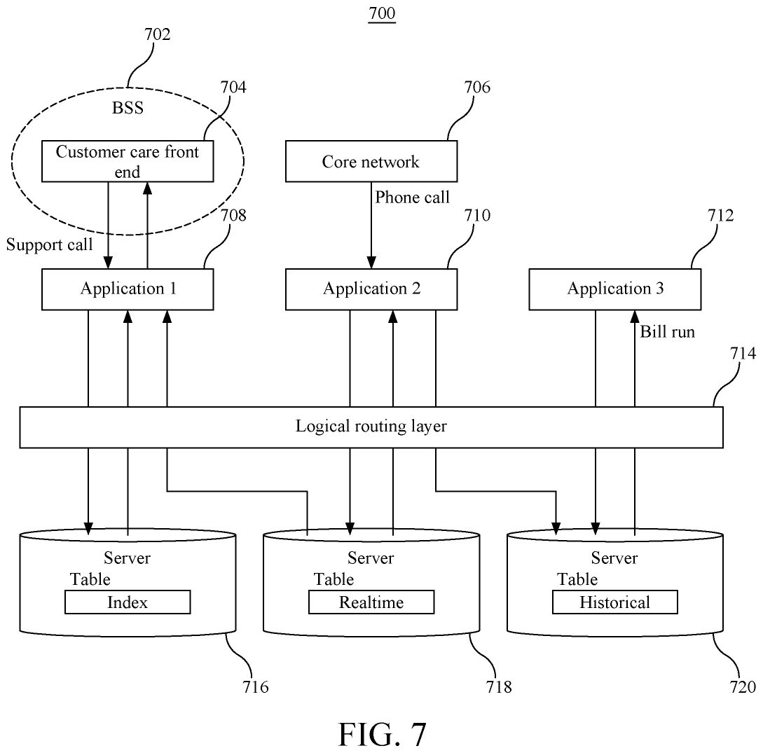

FIG. 7 shows an architecture which can support various use cases of the embodiments. The architecture 700 of FIG. 7 includes the BSS 702, a Customer Care front end 704, the Core network 706, Application1 708, Application2 710, Application 3 712, the logical routing layer 714, an index server 716, a real-time server 718 and a historical server 720. Three examples of use cases which can use the architecture shown in FIG. 7 include CC call, a customer interaction with the Core network 706 and a periodic bill run each of which will now be summarized and then described in detail.

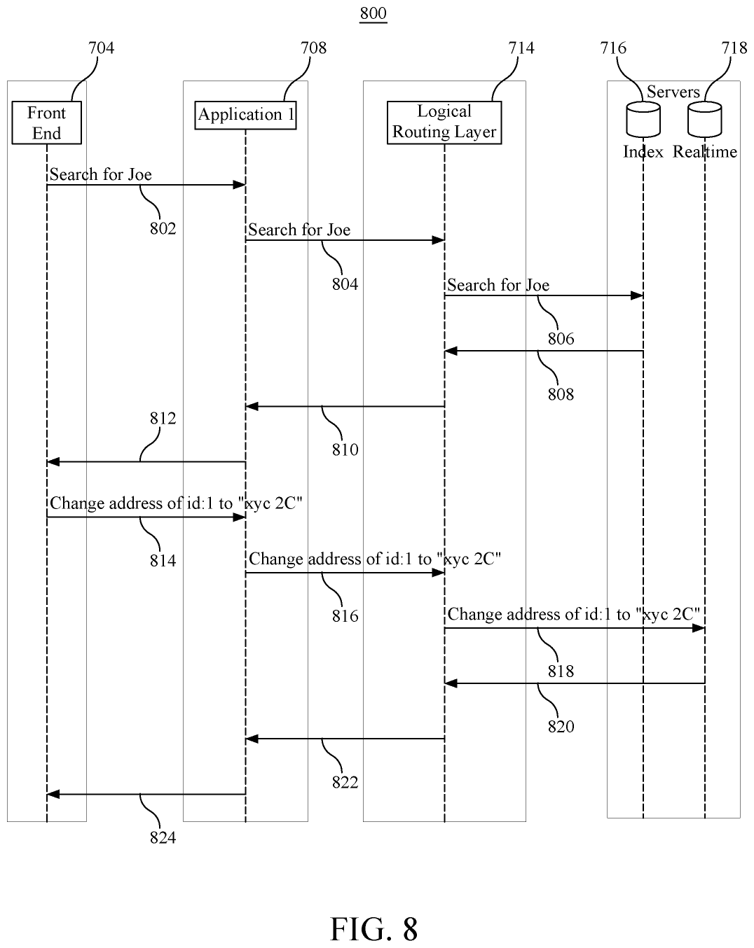

For the CC call example, a customer calls a CC agent and states his or her name. The CC agent then searches for the customer and retrieves his or her unique internal customer ID. This request is processed by the index server 716. For the core network 706 example, a customer places a phone call. The charging system listens on the core network and charges the phone call for the duration of the phone call. This request is processed by the real-time server 718. For the periodic bill run example, the bill for the month is run which requires a relatively large amount of processing since the run will accumulate all costs for customers for the previous month. This request is processed by the historical server 720. These three examples are described below in more detail with respect to the signaling diagrams shown in FIGS. 8-10. Further, according to an embodiment, the processing intensive operations performed by the historical server 720 will not affect the other applications, therefore, the support call and the phone call will be executed undisturbed as these servers 716 and 718 are isolated by the architecture 700's design in accordance with these embodiments.

As described above, FIG. 8 shows the signaling diagram associated with the CC call example associated with a customer changing their address using a system architected with the above-described embodiments. The signaling diagram 800 includes a front-end 704 (which represents the CC agent that took the call from the customer “Joe” and is now accessing the system), an Application1 708, the logical routing layer 714, the index server 716 and the real-time server 718. In this example, customer Joe has moved from address “abc 1B” to the new address of “xyz 2C”. Initially, after Joe has spoken with the CC agent (or informed the CC agent of the change in another manner), the CC agent uses the front-end 704 to submit the query to search for customer Joe as shown by arrow 802 which represents a message. The Application1 708 searches for Joe's name in the index server 716. This process is represented by query message 804 sent from Application1 708 to the logical routing layer 714 which forwards the query as shown in message 806 which is received by the index server 716.

The index server transmits the results in message 808 to the routing layer which forwards the message 808 as shown by arrow 810. Application1 708 then returns the information associated with Joe in message 812 to the Front-end 704. The CC agent then, using the Front-end 704, updates the change in Joe's address. This process is shown via messages 814, 816 and 818 in which the change of address information is sent to the real-time server for updating. Messages 820, 822 and 824 then show the messaging process of the real-time server informing the CC agent of the completion of the address change update which can then be seen via, e.g., a CC Front-end user interface.

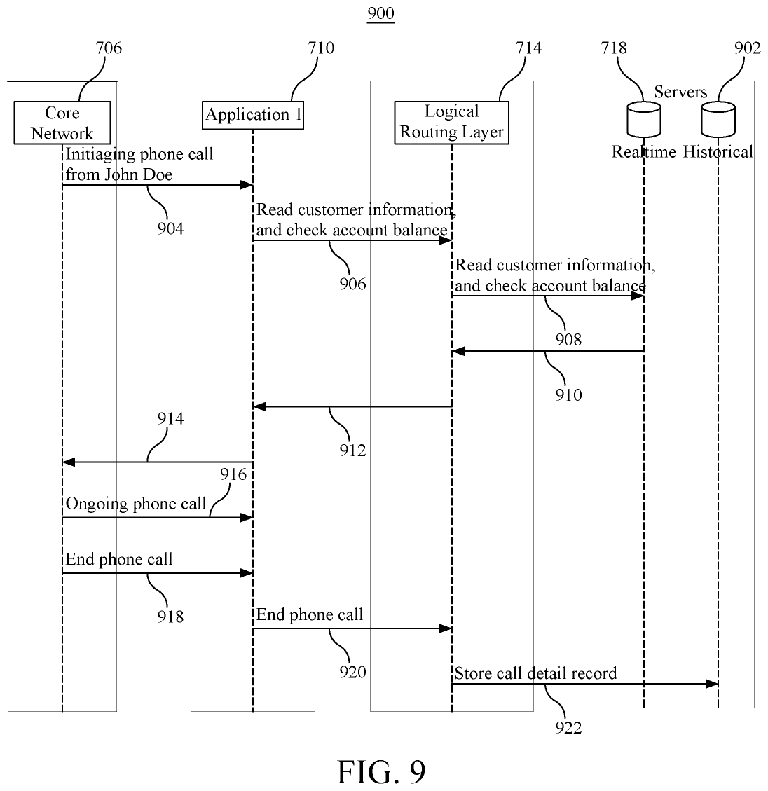

According to an embodiment, FIG. 9 shows a signaling diagram 900 associated charging activities associated with a phone call using a system in accordance with the embodiments. Initially, customer John makes a phone call. The core network 706 initiates a query 904 to the charging system, which is represented by Application2 710. Application2 710 then checks the account balance of Joe before allowing the phone call to proceed. This process of checking the customer's balance is shown in messages 906-914. More specifically, message 906 represents Application2 710 transmitting the request to read customer Joe's information and account balance to the logical routing layer 714 which forwards the request as message 908 to the appropriate server, in this case real-time server 718. Real-time server 718 than gathers the requested information and transmits the requested information via the logical routing layer 714 as shown by messages 910 and 912. Application2 710 then transmits message 914 which, in this case, informs the core network 706 that the phone call is to be allowed.

Once the phone call is allowed, the Application2 710 representing the charging system keeps track of the duration of the phone call. The ongoing phone call is represented by message 916 and ending the phone call by message 918. Once Application2 710 receives message 918, Application2 710 transmits this information as message 920 to the logical routing layer 714 which forwards this information as message 922 to the historical data server 920 for storage of the call detail record (CDR).

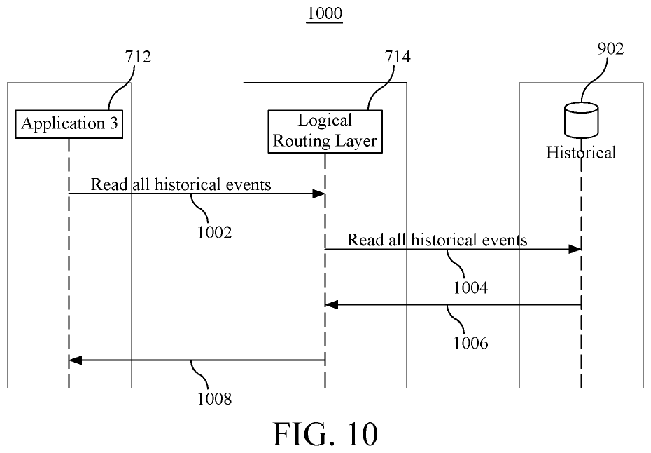

According to an embodiment, FIG. 10 shows a signaling diagram 1000 which illustrates a periodic bill run that calculates the total expenses for all customers for the past month using a database system architected in accordance with these embodiments. Application3 712 transmits instructions 1002 for reading all historical events for the period to the logical routing layer 714. The logical routing layer then routes these instructions in message 1004 to the historical data server 902 which then processes the periodic bill run. Results of the processing are transmitted back to Application3 712 as shown by messages 1006 and 1008.

According to an embodiment, in order to save on hardware costs, the proposed architecture can be used in edge computing solutions. Each application in the BSS system can have its own set of hardware, e.g., central processing unit (CPU), random access memory (RAM), etc. Different BSS components such as the charging system and a customer manager application have data dependencies between each other. The charging system which charges customers is dependent on the customer manager application, which both creates maintains all the customers in the BSS system.

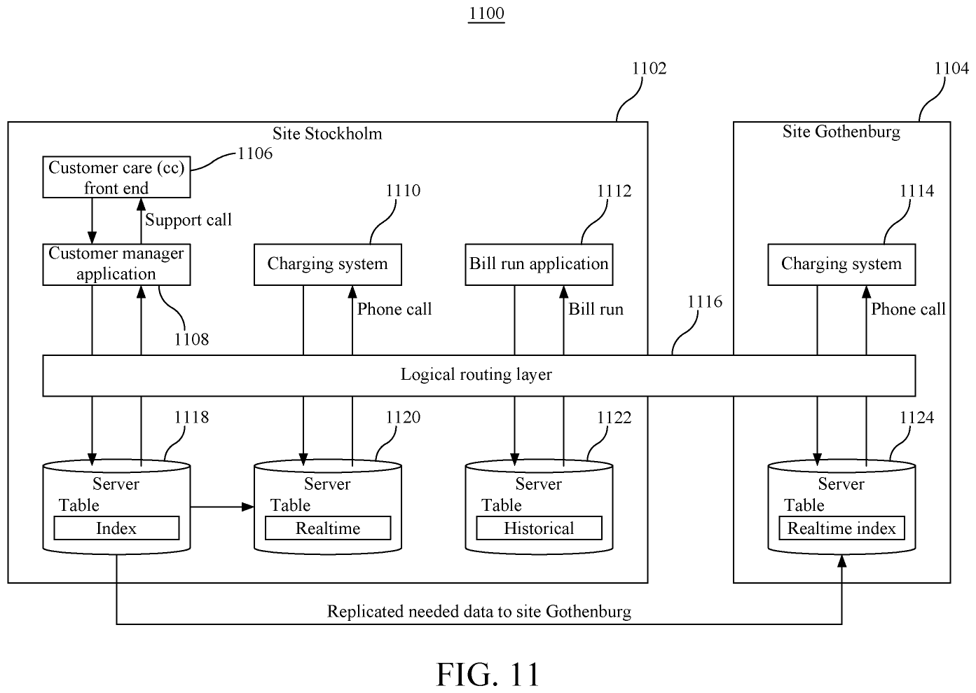

According to another embodiment, it is possible to deploy the charging system in a standalone fashion in a remote site, without other BSS applications. FIG. 11 shows an example of an architecture 1100 which includes both a complete system (to include all needed BSS components), site Stockholm 1102, and a partial system deployed at a remote site, site Gothenburg 1104. Site Stockholm 1102 includes a CC front end 1106, a customer manage application 1108, a charging system 1110 (which includes at least one application), a bill run application 1112, an index server 1118, a real-time server 1120 and a historical data server 1122. Site Gothenburg 1104 includes a charging system 1114 (which includes at least one application) and a server 1124 which includes both the functions/data of the index and the real-time server. A logical routing layer 1116 also operates in both Site Stockholm 1102 and Site Gothenburg 1104.

In this example, a hardware cost savings is made by not deploying the rest of the BSS applications/hardware, e.g., hardware and software associated with Customer Care and billing, at Site Gothenburg 1104. However, according to an embodiment, in order to avoid the charging system having to read the customer data across sites, which will have a high latency cost, the charging system data is represented locally in charging system 1114. By replicating the certain customer data from Site Stockholm 1102 to Site Gothenburg 1104, the charging system can read the customer data locally to avoid the network latency cost. According to an embodiment, the charging system 1114 at Site Gothenburg 1104 needs to be able to handle inconsistencies in data, as data might not be consistent between the sites at all points in time. Further, according to an embodiment, the embodiments shown in FIGS. 8-10 can also be implemented using the architecture in FIG. 11 with, for example, Application1 708, Application2 710 and Application3 712 being mapped to customer manager application 1108, charging system 1110 and bill run application 1112, respectively. Additionally, the charging system 1114 can perform the functions described with respect to Application2 710.

Embodiments described herein allow for having an architectural design where the customer data is split across different servers depending on the data category. By having a logical routing layer the applications do not need to provide any server details when routing requests. For the application, it will appear as a single database containing all of the data. Embodiments further allow customer data to be stored according to customer ID and the customer data type. Embodiments provide for a same or similar amount of latency regardless of what background jobs are running in the BSS system, by providing isolation between severs handling different data categories. The customer data is still stored in one distributed database system, but distributed according to the storage or processing need. Further, by having several server groups handling different customer data, different hardware can also be used in order to be more cost efficient. Different replication factors can also be used in cases where data is more important or less importantly. Additionally, embodiments can be applied to solve edge computing use cases.

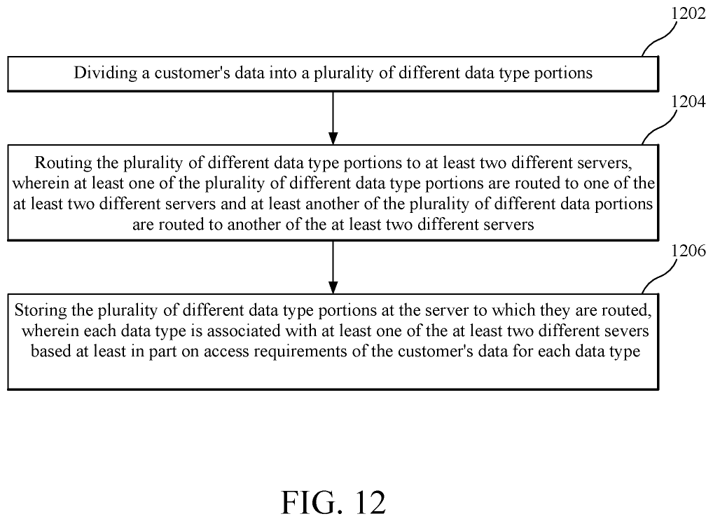

According to an embodiment there is a method 1200 for storing customer data in a distributed database as shown in FIG. 12. The method includes: in step 1202, dividing a customer's data into a plurality of different data type portions; in step 1204, routing the plurality of different data type portions to at least two different servers, wherein at least one of the plurality of different data type portions are routed to one of the at least two different servers and at least another of the plurality of different data portions are routed to another of the at least two different servers; and in step 1206, storing the plurality of different data type portions at the server to which they are routed, wherein each data type is associated with at least one of the at least two different servers based at least in part on access requirements of the customer's data for each data type.

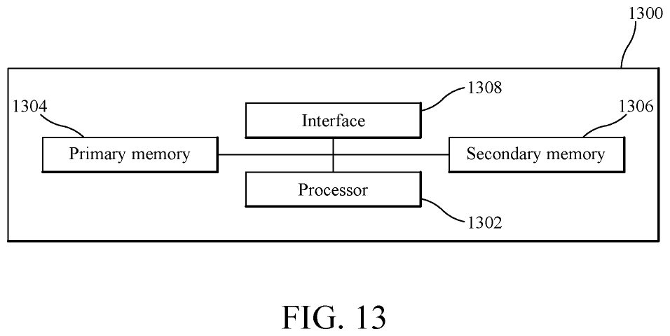

Embodiments described above can be implemented in one or more servers. An example of such a server 1300 is shown in FIG. 13. The server 1300 (or other network node) includes a processor 1302 for executing instructions and performing the functions described herein. The server 1300 also includes a primary memory 1304, e.g., random access memory (RAM) memory, a secondary memory 1306 which can be a non-volatile memory, and an interface 1308 for communicating with other portions of a network or among various nodes/servers if, for example, the various functional modules are distributed over multiple servers.

Processor 1302 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other server 1300 components, such as memory 1304 and/or 1306, server 1300 functionality. For example, processor 1302 may execute instructions stored in memory 1304 and/or 1306.

Primary memory 1304 and secondary memory 1306 may comprise any form of volatile or non-volatile computer readable memory including, without limitation, persistent storage, solid state memory, remotely mounted memory, magnetic media, optical media, RAM, read-only memory (ROM), removable media, or any other suitable local or remote memory component. Primary memory 1304 and secondary memory 1306 may store any suitable instructions, data or information, including software and encoded logic, utilized by server 1300. Primary memory 1304 and secondary memory 1306 may be used to store any calculations made by processor 1302 and/or any data received via interface 1308.

Server 1300 also includes interface 1308 which may be used in the wired or wireless communication of signaling and/or data. For example, interface 1308 may perform any formatting, coding, or translating that may be needed to allow server 1300 to send and receive data over a wired connection. Interface 1308 may also include a radio transmitter and/or receiver that may be coupled to or a part of the antenna. The radio may receive digital data that is to be sent out to other network nodes or wireless devices via a wireless connection. The radio may convert the digital data into a radio signal having the appropriate channel and bandwidth parameters. The radio signal may then be transmitted via an antenna to the appropriate recipient.

According to an embodiment, the methods described herein can be implemented on one or more servers 1300 with these servers 1300 being located within the online charging system or distributed in a cloud architecture associated with an operator network. Cloud computing can be described as using an architecture of shared, configurable resources, e.g., servers, storage memory, applications and the like, which are accessible on-demand. Therefore, when implementing embodiments using the cloud architecture, more or fewer resources can be used to, for example, perform the database and architectural functions described in the various embodiments herein. For example, servers 1300 distributed in cloud environments could act as a historical data server 1122 without degrading the access of the other data servers.

Embodiments described herein allow for having an architectural design where the customer data is split across different servers depending on the data category. By having a logical routing layer the applications do not need to provide any server details when routing requests. For the application, it will appear as a single database containing all of the data. Embodiments further allow customer data to be stored according to customer ID and the customer data type. Embodiments provide for a same or similar amount of latency regardless of what background jobs are running in the BSS system, by providing isolation between severs handling different data categories. The customer data is still stored in one distributed database system, but distributed according to the storage or processing need. Further, by having several server groups handling different customer data, different hardware can also be used in order to be more cost efficient. Different replication factors can also be used in cases where data is more important or less importantly. Additionally, embodiments can be applied to solve edge computing use cases.

Additionally, while embodiments described herein have described a telecommunication environment, the exemplary distributed database and associated hardware can be applied to other environments and industries including, but not limited to, services which have varied data processing requirement. Embodiments also allow for having designated groups of servers per datatype which provides an advantage of achieving full isolation between the data being processed between different server groups. For example, when invoices are being calculated, the real-time processing of phone calls can run undisturbed. This is desired as it allows for customers to have a good customer experience. Further, different types of hardware can be used for each datatype. For example, solid SSDs can be used for server groups processing real-time data, and for historical data, such as calculating invoices, spinning disks can be used. This can lower the cost for the operator while also allowing for having bigger spinning disks for server groups which store historical data. Additionally, different replication factors can be set within the server group(s), depending on the importance of the data stored.

The disclosed embodiments provide methods and devices for distributing data. It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the claimed invention. However, one skilled in the art would understand that various embodiments may be practiced without such specific details.

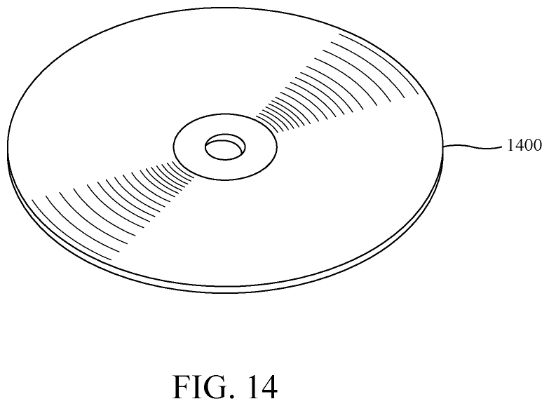

As also will be appreciated by one skilled in the art, the embodiments may take the form of an entirely hardware embodiment or an embodiment combining hardware and software aspects. Further, the embodiments, e.g., the configurations and other logic associated with databases to include embodiments described herein, such as, the method associated with FIG. 12, may take the form of a computer program product stored on a computer-readable storage medium having computer-readable instructions embodied in the medium. For example, FIG. 14 depicts an electronic storage medium 1400 on which computer program embodiments can be stored. Any suitable computer-readable medium may be utilized, including hard disks, CD-ROMs, digital versatile disc (DVD), optical storage devices, or magnetic storage devices such as floppy disk or magnetic tape. Other non-limiting examples of computer-readable media include flash-type memories or other known memories.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

1-25. (canceled)

26. A method for storing customer data in a distributed database, the method comprising:
dividing a customer's data into a plurality of different data type portions;
routing the plurality of different data type portions to at least two different servers, wherein at least one of the plurality of different data type portions are routed to one of the at least two different servers and at least another of the plurality of different data portions are routed to another of the at least two different servers; and
storing the plurality of different data type portions at the server to which they are routed;
wherein each data type is associated with at least one of the at least two different servers based at least in part on access requirements of the customer's data for each data type.

27. The method of claim 26, wherein access requirements include access frequency, access speed, latency, and/or security requirements associated with the plurality of different data type portions.

28. The method of claim 26, wherein the plurality of different data type portions includes schedule data, index data, real-time data, historical data, and sensitive data.

29. The method of claim 26, wherein schedule data, index data, and real-time data are stored together on a first server of the at least two different servers; and wherein historical data is stored on a second server of the at least two different servers.

30. The method of claim 26, wherein the routing the plurality of different data type portions to the at least two different servers is performed by a logical routing layer which includes a client-side element and a server-side element.

31. The method of claim 30, wherein the client-side element is configured to forward a data query for a customer; and wherein the client-side element is configured to forward customer data to be stored.

32. The method of claim 31, wherein the server-side element of the logical routing layer determines which data type of the plurality of different data types is applicable for both the data query for the customer and the customer data to be stored.

33. The method of claim 30, wherein, when receiving customer's data from the client-side of the logical routing layer, the server-side element of the logical routing layer determines what type of data is received from the client side element of the logical routing layer and which server of the at least two different servers is to be used to store the received customer's data.

34. A system for storing customer data in a distributed database, the system comprising:
a logical routing layer configured to divide a customer's data into a plurality of different data type portions; wherein the logical routing layer is further configured to route the plurality of different data type portions to at least two different servers; wherein at least one of the plurality of different data type portions are routed to one of the at least two different servers and at least another of the plurality of different data portions are routed to another of the at least two different servers; wherein the logical routing layer exists at least on the two different servers and on at least one client device; and
the servers to which the plurality of different data type portions are routed, the servers configured to store the plurality of different data type portions;
wherein each type of data is associated with at least one of the at least two different servers based at least in part on access requirements of the customer's data for each data type.

35. The system of claim 34, wherein access requirements include access frequency, access speed, latency, and/or security requirements associated with the plurality of different data type portions.

36. The system of claim 34, wherein the plurality of different data type portions includes schedule data, index data, real-time data, historical data, and sensitive data.

37. The system of claim 36, wherein schedule data, index data, and real-time data are stored together on a first server of the at least two different servers; and wherein historical data is stored on a second server of the at least two different servers.

38. The system of claim 34, wherein, for infrequent access of the customer's data, the customer's data is stored on spinning disks.

39. The system of claim 34, wherein, for frequent access of the customer's data, the customer's data is stored on a solid-state drive.

40. The system of claim 34, wherein the logical routing layer includes a client-side element and a server-side element.

41. The system of claim 40, wherein the client-side element is configured to forward a data query for a customer; and wherein the client-side element is configured to forward customer data to be stored.

42. The system of claim 41, wherein the server-side element of the logical routing layer determines which data type of the plurality of different data types is applicable for both the data query for the customer and the customer data to be stored.

43. The system of claim 40, wherein the server-side element of the logical routing layer, when receiving customer's data from the client-side of the logical routing layer, determines what type of data is received from the client side element of the logical routing layer and which server of the at least two different servers is to be used to store the received customer's data.

44. A non-transitory computer readable recording medium storing a computer program product for controlling the storing of customer data in a distributed database, the computer program product comprising program instructions which, when run on processing circuitry of a system, causes the system to:
divide a customer's data into a plurality of different data type portions;
route the plurality of different data type portions to at least two different servers, wherein at least one of the plurality of different data type portions are routed to one of the at least two different servers and at least another of the plurality of different data portions are routed to another of the at least two different servers; and
store the plurality of different data type portions at the server to which they are routed;
wherein each data type is associated with at least one of the at least two different servers based at least in part on access requirements of the customer's data for each data type.

45. An apparatus, comprising:
processing circuitry;
memory containing instructions executable by the processing circuitry whereby the apparatus is operative to:
divide a customer's data into a plurality of different data type portions;
route the plurality of different data type portions to at least two different servers; wherein at least one of the plurality of different data type portions are routed to one of the at least two different servers and at least another of the plurality of different data portions are routed to another of the at least two different servers; and
store the plurality of different data type portions at the server to which they are routed;
wherein each data type is associated with at least one of the at least two different servers based at least in part on access requirements of the customer's data for each data type.
